(19) United States
(12) Patent Application Publication
(10) Pub. No.: US 2026/0070451 A1
(43) Pub. Date: Mar. 12, 2026

(54) FUSION DETECTION CONTROL SYSTEM AND METHOD FOR VEHICLE BATTERY CHARGING RELAY

(71) Applicants: Hyundai Motor Company, Seoul (KR); Kia Corporation, Seoul (KR)

(72) Inventors: Dae-Hyun Kim, Hwaseong-si (KR); Sung-Il Jung, Hwaseong-si (KR); Dong-Geon Lee, Hwaseong-si (KR)

(21) Appl. No.: 19/082,822

(22) Filed: Mar. 18, 2025

(30) Foreign Application Priority Data
Sep. 9, 2024 (KR) 10-2024-0122344

(51) Int. Cl. B60L 53/62; B60L 53/16

(52) U.S. Cl. CPC B60L 53/62; B60L 53/16

(57) ABSTRACT

In a fusion detection control system for a vehicle battery charging relay, the system can include a high-voltage battery, a high-voltage junction box combined with the high-voltage battery to distribute power from the high-voltage battery to a high-voltage component of a vehicle, and a charge controller configured to detect whether a relay of the high-voltage junction box is fused after the completion of charging of the high-voltage battery.

### CROSS-REFERENCE TO RELATED APPLICATIONS

This application claims priority to Korean Patent Application No. 10-2024-0122344, filed on Sep. 9, 2024 which is incorporated herein by reference in its entirety.

### TECHNICAL FIELD

The present disclosure relates to a system and method for detecting and controlling relay fusion in vehicle battery charging systems.

### BACKGROUND

Electric vehicles are equipped with a fusion diagnosis sequence of a vehicle charging relay to perform fusion diagnosis prior to starting a charging operation. For the user's safety, it is necessary to determine the fusion before and after the start of charging, but the fusion diagnosis is not determined because the information provided by a charger after the charging operation is inaccurate. However, for the user's safety, it is necessary to determine the fusion of the vehicle charging relay before and after the charging operation, and if it is determined to be fused (including misjudgment), it will cause great disadvantages in terms of product quality due to inability to start the vehicle and inability to use the radio/air conditioner/heater, etc.

The foregoing background description is intended to provide an understanding of the background of the present disclosure, and may include matters that are not the related art technology already publicly known, available, or in use.

### SUMMARY

An embodiment of the present disclosure can provide a system and method for fusion detection and fire protection during high-voltage charging of eco-friendly vehicles. An embodiment of the present disclosure can provide a fusion detection control system and method for a vehicle battery charging relay for solving a conventional problem of not ensuring the user's safety due to both the determination of the fusion being only performed prior to the start of the fusion during high-voltage charging and the lack of a separate high-voltage off system even in the occurrence of the fusion, and at the same time, for ensuring productivity (ability to start the vehicle, and ability to use the radio/air conditioner, etc.).

An embodiment of the present disclosure can provide a fusion detection control system for a vehicle battery charging relay, and the system can include: a high-voltage battery; a high-voltage junction box combined with the high-voltage battery to distribute power from the high-voltage battery to a high-voltage component of a vehicle; and a charge controller configured to detect whether a relay of the high-voltage junction box is fused after the completion of charging of the high-voltage battery.

The charge controller may be configured so that the charge controller compares a voltage of electric vehicle supply equipment (EVSE) and a voltage of the high-voltage component, and if a difference in voltage between the EVSE and the high-voltage component is not less than a set value, the charge controller can determine the absence of a fusion situation, and if the difference is less than the set value, the charge controller can determine the presence of the fusion situation.

The set value may be 50±5 V.

The charge controller may be configured so that after the completion of charging, if the relay of the high-voltage junction box is determined to be fused, the charge controller can control a relay of the high-voltage battery to switch Off.

The charge controller may be configured so that after the completion of charging, if the relay of the high-voltage junction box is determined to be fused, the charge controller can check whether a charging port flap is opened or closed, and if the charging port flap is determined to be opened, the charge controller can control the relay of the high-voltage battery to switch Off.

The charge controller may be configured so that the charge controller can check whether a charging port flap is opened or closed, and if the charging port flap is determined to be closed, the charge controller can control the relay of the high-voltage battery to switch On.

The charge controller may be configured so that in response to a request for entry into a charging stage, the charge controller can check a variable value associated with the presence or absence of a fusion situation, previously stored in a memory to determine whether the charging port flap is opened or closed in the event of the fusion situation, and if the charging port flap is determined to be opened, the charge controller can control the relay of the high-voltage battery to switch Off.

The charge controller may be configured so that the charge controller checks whether the charging port flap is opened or closed, and if the charging port flap is determined to be closed, the charge controller can control the relay of the high-voltage battery to switch On.

The charge controller may be configured so that in response to a request for entry into a charging stage, the charge controller can determine whether the relay of the high-voltage junction box is fused before charging of the high-voltage battery, and if the relay of the high-voltage junction box is determined to be fused before charging of the high-voltage battery, the charge controller can control the relay of the high-voltage battery to switch Off.

The charge controller may be configured so that if the relay of the high-voltage junction box is determined to be fused before charging of the high-voltage battery, the charge controller can check whether the charging port flap is opened or closed, and if the charging port flap is determined to be opened, the charge controller can control the relay of the high-voltage battery to switch Off, and if the charging port flap is determined to be closed, the charge controller can control the relay of the high-voltage battery to switch On.

An embodiment of the present disclosure can provide a fusion detection control method for a vehicle battery charging relay, and the method can include: charging a high-voltage battery in response to a request for entry into a charging stage; and after the completion of charging of the high-voltage battery, checking whether a relay of a high-voltage junction box is fused, the high-voltage junction box being combined with the high-voltage battery to distribute power from the high-voltage battery to a high-voltage component of a vehicle.

The stage of checking whether the relay of the high-voltage junction box is fused may include comparing a voltage of electric vehicle supply equipment (EVSE) and a voltage of the high-voltage component, determining the absence of a fusion situation if a difference in voltage between the EVSE and the high-voltage component is not less than a set value, and determining the presence of the fusion situation if the difference is less than the set value.

The method may further include: if the relay of the high-voltage junction box is determined to be fused in the stage of checking the fusion situation of the relay of the high-voltage junction box, checking whether a charging port flap is opened or closed; and if the charging port flap is determined to be opened, controlling the relay of the high-voltage battery to switch Off.

The method may further include: if the charging port flap is determined to be closed in the stage of checking the opened or closed state of the charging port flap, controlling the relay of the high-voltage battery to switch On.

The method may further include: in response to a request for entry into a charging stage prior to the charging stage, checking a variable value associated with the presence or absence of a fusion situation, previously stored in a memory; and if the fusion situation is determined to be presented in the stage of checking the variable value associated with the presence or absence of the fusion situation, checking whether the charging port flap is opened or closed.

The method may further include: if the charging port flap is determined to be opened in the stage of checking the opened or closed state of the charging port flap, controlling the relay of the high-voltage battery to switch Off; and if the charging port flap is determined to be closed in the stage of checking the opened or closed state of the charging port flap, controlling the relay of the high-voltage battery to switch On.

The method may further include: if the fusion situation is determined to be presented in the stage of checking the variable value associated with the presence or absence of the fusion situation, checking whether the relay of the high-voltage junction box is fused before charging of the high-voltage battery; and if the relay of the high-voltage junction box is determined to be fused in the stage of checking the fusion situation of the relay of the high-voltage junction box before charging of the high-voltage battery, checking whether the charging port flap is opened or closed.

The method may further include: if the charging port flap is determined to be opened in the stage of checking the opened or closed state of the charging port flap, controlling the relay of the high-voltage battery to switch Off; and if the charging port flap is determined to be closed in the stage of checking the opened or closed state of the charging port flap, controlling the relay of the high-voltage battery to switch On.

According to an embodiment of the present disclosure, in the event of a fusion situation in the vehicle battery charging relay, the driver's safety may be ensured against hazards such as arcing and explosion.

According to an embodiment of the present disclosure, in the event of a fusion situation, condition-specific high-voltage control does not affect the driver's ability to start and drive a vehicle, listen to the radio, operate the air conditioner, etc., thereby securing vehicle productivity.

### BRIEF DESCRIPTION OF THE DRAWINGS

FIG. 1 illustrates a conventional control method in a normal situation;

FIG. 2 illustrates a conventional control system in a normal situation;

FIG. 3 illustrates a conventional control method in a fusion situation;

FIG. 4 illustrates a conventional control system in a fusion situation;

FIG. 5 is a schematic flow diagram illustrating a control method according to an embodiment of the present disclosure;

FIG. 6 is a schematic illustration of a fusion detection control system for a vehicle battery charging relay according to an embodiment of the present disclosure;

FIG. 7 illustrates an operating state in a normal situation of the fusion detection control system for a vehicle battery charging relay according to an embodiment of the present disclosure;

FIG. 8 illustrates an operating state in a fusion situation of the fusion detection control system for a vehicle battery charging relay according to an embodiment of the present disclosure;

FIG. 9 illustrates a controlled state of a high-voltage component in a fusion situation of the fusion detection control system for a vehicle battery charging relay according to an embodiment of the present disclosure;

FIGS. 10 and 11 illustrate a detailed controlled state of the high-voltage component in a fusion situation of the fusion detection control system for a vehicle battery charging relay according to an embodiment of the present disclosure; and

FIGS. 12 and 13 illustrate a fusion detection control method for a vehicle battery charging relay according to an embodiment of the present disclosure.

### DETAILED DESCRIPTION OF ILLUSTRATIVE EMBODIMENTS

To fully appreciate the purpose, operation, and operational advantages of an embodiment of the present disclosure, reference can be made to the accompanying drawings, which illustrate example embodiments of the present disclosure, and to the description thereof.

In describing example embodiments of the present disclosure, any description or repetition of the disclosure that would unnecessarily obscure the essence of the present disclosure can be hereby reduced or omitted.

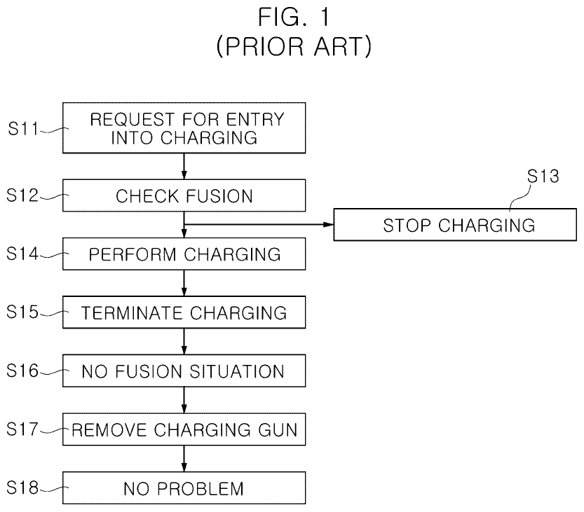

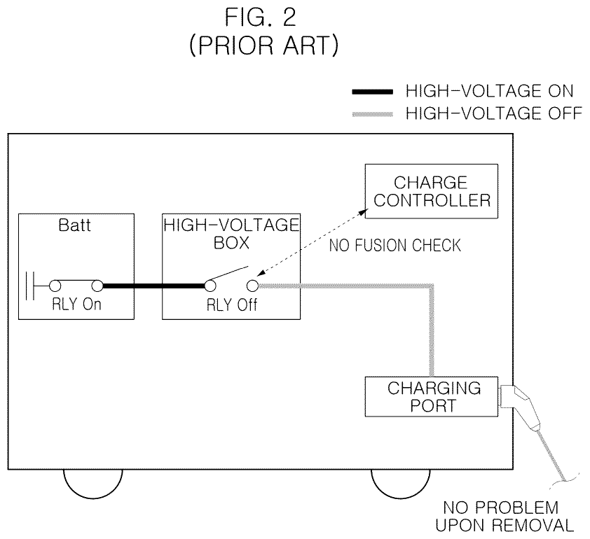

FIG. 1 illustrates a conventional control method in a normal situation. FIG. 2 illustrates a conventional control system in a normal situation. In FIG. 2, the vehicle battery charging system includes a high-voltage battery (labeled “Batt”), a high-voltage junction box, and a charge controller, wherein charging is carried out by coupling a charging gun to a charging port, and as illustrated, in a normal situation, a relay of the high-voltage battery is in the On state, and a relay of the high-voltage junction box is in the Off state.

In conventional charging, the fusion determination is performed only before the start of charging, and in a normal situation, as illustrated in FIG. 1, the fusion checking is performed (operation S12) in response to a request for entry into a charging stage (operation S11), and the charging is stopped when the fusion situation occurs (operation S13).

If no fusion situation occurs, the charging process terminates charging (operation S15) through a charging stage (operation S14), and if no fusion situation occurs (operation S16), the charging gun is removed (operation S17). In this normal situation, no problem occurs (operation S18).

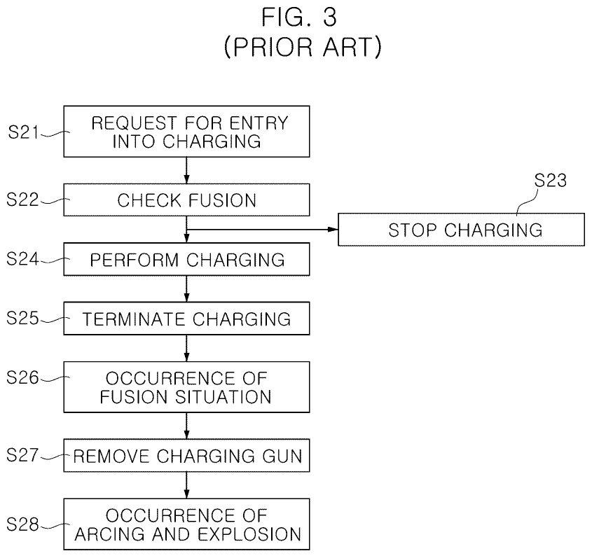

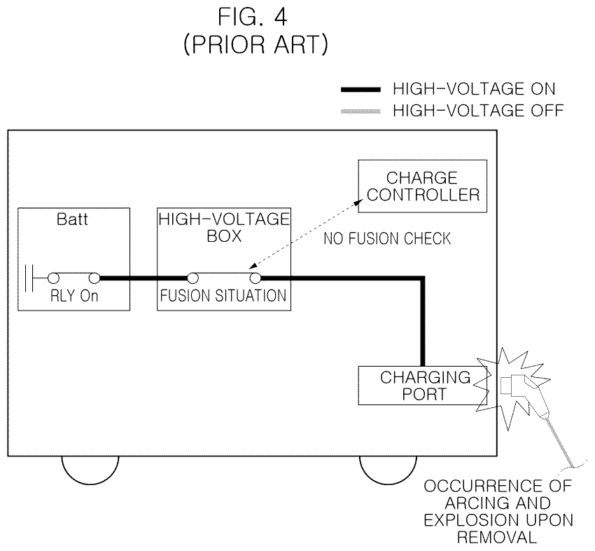

FIG. 3 illustrates a conventional control method in a fusion situation. FIG. 4 illustrates a conventional control system in a fusion situation. In a fusion situation, as illustrated in FIGS. 3 and 4, a relay of the high-voltage battery is in an On state, and a relay of the high-voltage junction box is in a state in which a fusion situation has occurred.

When a request for entry into a charging stage is made (operation S21), a fusion check is performed (operation S22), and charging is stopped if the fusion situation occurs (operation S23).

If no fusion situation occurs, the charging is terminated (operation S25) through the charging stage (operation S24), and if the fusion situation occurs (operation S26), the charging gun is removed (operation S27). In such a fusion situation, arcing and explosion occurs when the charging gun is removed (operation S28).

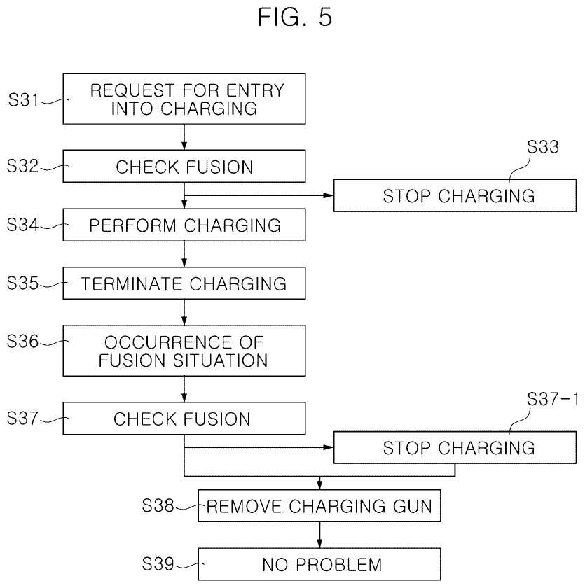

An embodiment of the present disclosure can improve this situation, and as illustrated in FIG. 5, a fusion check can be performed (operation S32) upon a request for entry into a charge stage (operation S31), and charging can be stopped if the fusion situation occurs (operation S33).

If no fusion situation occurs, charging can be terminated (operation S35) through a charging stage (operation S34), and in a situation where fusion occurs after charging (operation S36), a fusion check can be performed after charging (operation S37).

As a result, the charging can be stopped (operation S37-1) upon the determination of the fusion situation, and the charging gun can be removed (operation S38) to prevent a problem from occurring (operation S39).

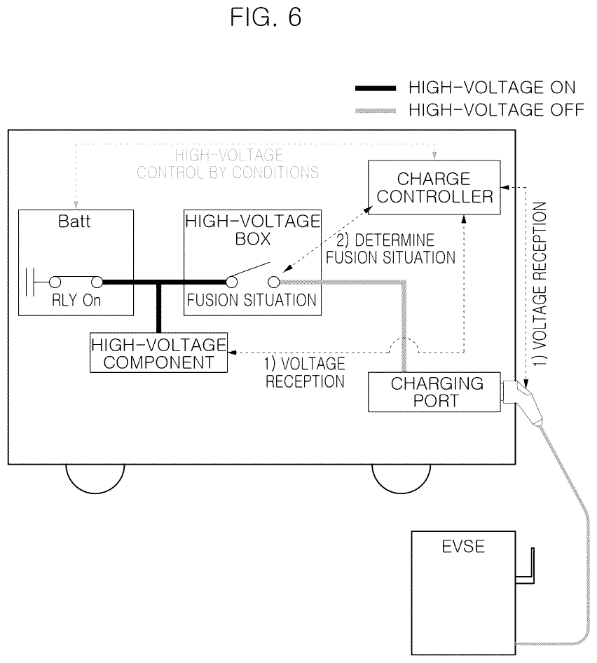

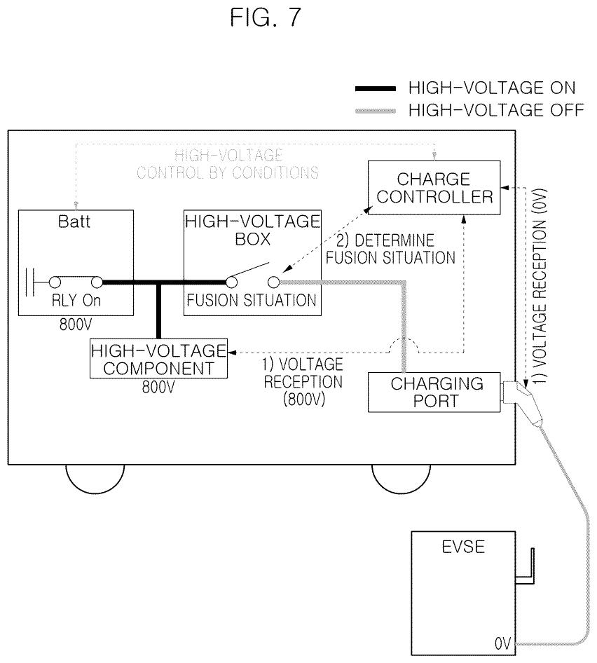

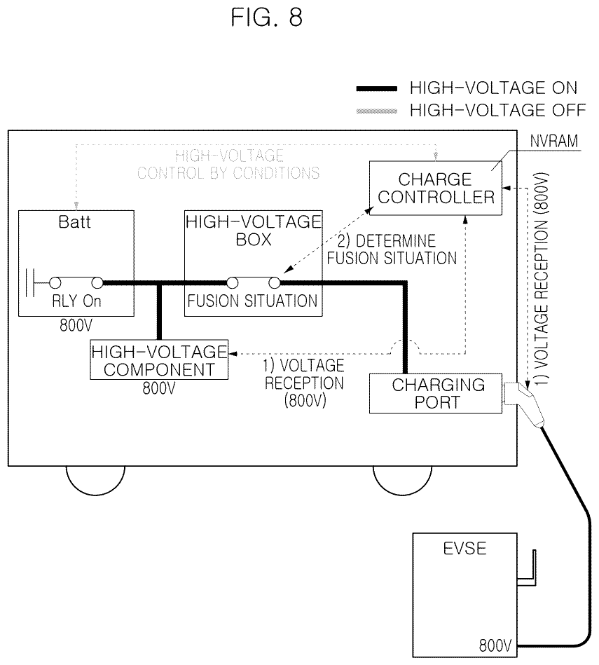

FIG. 6 is a schematic illustration of a fusion detection control system for a vehicle battery charging relay according to an embodiment of the present disclosure. FIG. 7 illustrates an operating state in a normal situation of the fusion detection control system for a vehicle battery charging relay according to an embodiment of the present disclosure. FIG. 8 illustrates an operating state in a fusion situation of the fusion detection control system for a vehicle battery charging relay according to an embodiment of the present disclosure.

Hereinafter, a fusion detection control system and method for a vehicle battery charging relay according to an example embodiment of the present disclosure will be described with reference to FIGS. 6 to 8.

As illustrated in FIG. 6, a vehicle battery charging system can include a high-voltage battery (labeled as “Batt”), a high-voltage junction box, and a charge controller, where power of the high-voltage battery can be distributed by the high-voltage junction box and used in high-voltage components of a vehicle.

An embodiment of the present disclosure can implement a fusion detection logic after completion of charging, so as to detect the fusion situation through comparison in a voltage between a charger and a vehicle high-voltage component and maintain the fusion-detected state.

First, a voltage level of electric vehicle supply equipment (EVSE) can be received through power line communication (PLC) communication, and a voltage level of the vehicle high-voltage component can be received through controller area network (CAN) communication.

Then, if a difference in two voltage levels is not less than a set value, e.g. 50±5 V, the situation can be determined as a normal situation, and if the difference is less than 50±5 V, the situation can be determined as a fusion situation.

Next, a variable value associated with the presence or absence of the fusion situation can be stored in non-volatile random access memory (NVRAM) to maintain the fusion-detected state during subsequent charging.

In this way, by maintaining the determination of the presence or absence of the fusion situation, it can be possible to prevent accidents caused by the presence of the fusion situation every time the driver attempts to charge.

FIG. 7 illustrates an operating state in a normal situation of the fusion detection control system for a vehicle battery charging relay according to an embodiment of the present disclosure.

In the normal situation, as illustrated, the relay of the high-voltage battery can be in the On state and the relay of the high-voltage junction box is in the Off state.

A high-voltage component of a vehicle can be applied with a battery voltage of about 800V because the battery relay is in the On state.

In the case of the EVSE, the relay of the high-voltage junction box (charging relay) can be in the Off state, so the voltage of the EVSE can drop to about 0 V.

Therefore, when comparing the vehicle high voltage and the EVSE voltage in the normal situation, there can be a voltage difference of 50 V or more, and the charge controller may determine that it is a normal situation rather than a fusion situation through this information.

FIG. 8 illustrates an operating state in a fusion situation of the fusion detection control system for a vehicle battery charging relay according to an embodiment of the present disclosure.

In the fusion situation, as illustrated, the relay of the high-voltage battery can be in the On state, and the relay of the high-voltage junction box can be in the fused state.

A high-voltage component of a vehicle can be applied with a battery voltage of about 800 V because the battery relay is in the On state.

In the case of EVSE, a voltage of EVSE can be not dropped and can maintain about 800 V, which can be a battery voltage for example, because the high-voltage box relay (charging relay) is fused.

Therefore, when comparing the vehicle high voltage and EVSE voltage in the fusion situation, a voltage difference of 50 V or more can be not occurring, so the charge controller may determine the fusion situation based on this information.

Furthermore, the fusion situation can be stored in the charge controller NVRAM so that the charge controller may continue to determine the fusion situation during subsequent charging attempts.

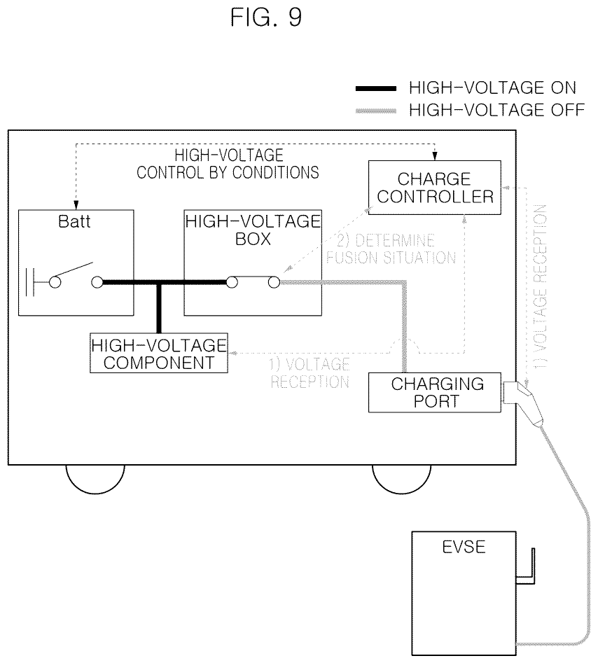

An embodiment of the present disclosure can further include logic to control the high-voltage components according to conditions after determining the presence of the fusion situation. FIG. 9 is an illustration of a high-voltage component control state in a fusion situation in a fusion detection control system for a vehicle battery charging relay according to an embodiment of the present disclosure.

In the event of a fusion situation, as illustrated, a high voltage can be connected to a charging port, which can cause arcing and explosion hazards when the user removes a charging gun from the charging port.

Therefore, in an embodiment, the high-voltage relay can be controlled by conditions as follows.

The high-voltage relay off condition can be controlled as Off only when the user is willing to attempt charging.

The user's intention to charge can be determined when a door of a charging port flap is opened, and in other situations, the high-voltage relay can be switched On so that the high-voltage components may be applied with power to secure user's convenience in performing vehicle-starting, an infotainment operation, an air conditioning operation, etc., for example.

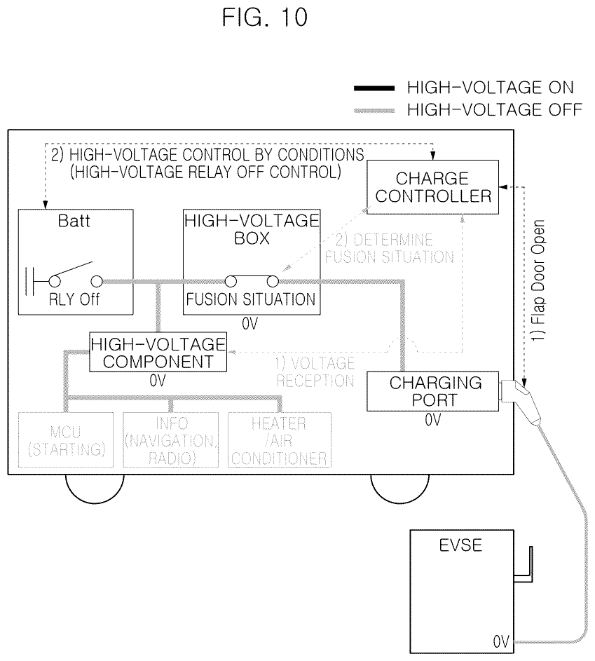

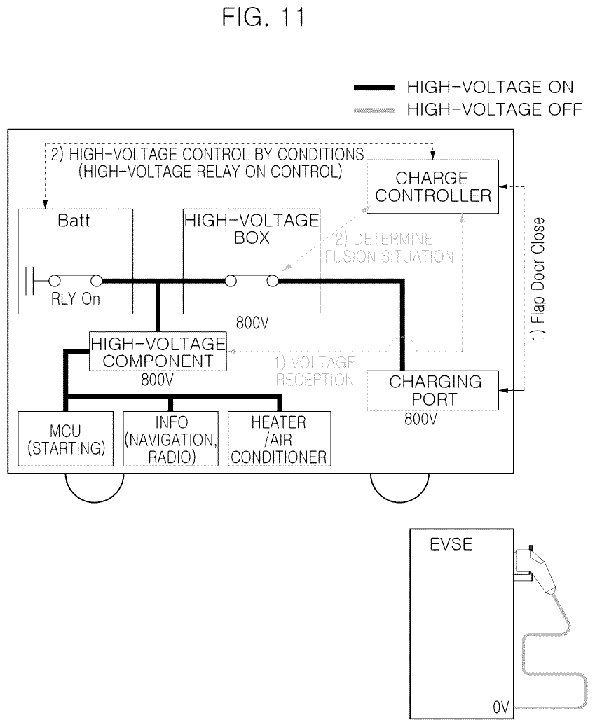

More specifically, FIGS. 10 and 11 illustrate a detailed controlled state of the high-voltage component in a fusion situation of the fusion detection control system for a vehicle battery charging relay according to an embodiment of the present disclosure.

As illustrated in FIG. 10, in the case of the driver's intention to charge, as described below, the relay of the high-voltage battery can be controlled to switch Off before or after the start of charging, such as when the fusion situation occurs and the charging flap door is opened.

After charging starts, the high voltage can be controlled to switch Off to reduce the voltage at the charging port to 0 V to prevent the risk of explosion and arcing when the user removes the charging gun.

Before charging starts, the high voltage can be controlled to switch Off to reduce the voltage at the charging port to 0 V to prevent the risk of explosion and arcing when the user engages the charging gun.

As illustrated in FIG. 11, in the case of the driver's intention to charge, if the charging flap door is closed to ensure the vehicle's productivity even upon the presence of the fusion situation, the high voltage can be controlled to switch On as described below.

In other words, when the driver does not intend to charge (e.g., Flap Door Close), the high-voltage relay can be controlled to switch On to ensure the vehicle's productivity, and the charging gun is not engaged or disengaged, so no explosion or arcing occurs.

Thus, in an embodiment, the driver's desired vehicle functions such as a vehicle-starting operation, an air conditioning operation, a heater operation, a radio operation, etc. can be not restricted.

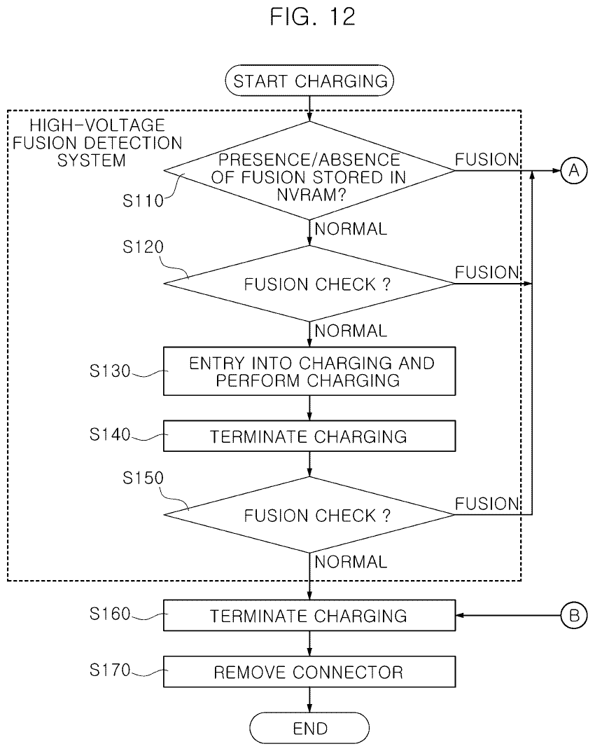

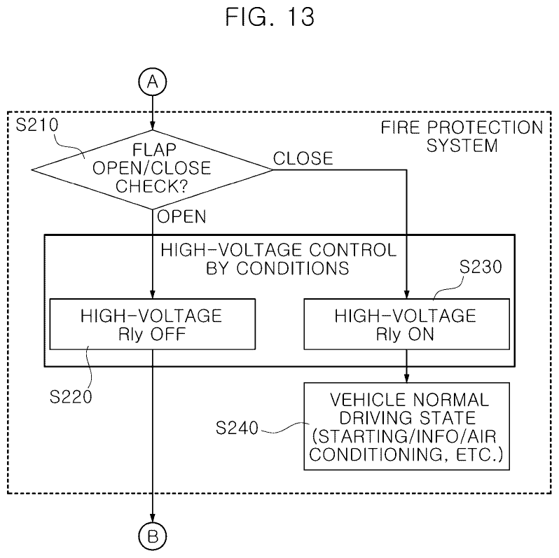

Next, FIGS. 12 and 13 illustrate a fusion detection control method for a vehicle battery charging relay according to an embodiment of the present disclosure.

With reference to these figures, the fusion detection control method for a vehicle battery charging relay according to an example embodiment of the present disclosure will be described as follows.

When charging starts, the charge controller first can check for the presence or absence of the fusion situation, which can be previously stored in the NVRAM memory (operation S110), and if there is a fusion situation, can perform further control to prevent fire.

Then, if there is no previously stored fusion history, the charge controller can perform a pre-charge fusion check (operation S120) according to the method described above, and can perform additional controls to prevent fire if a fusion situation is present.

If the pre-charging fusion check is determined to be normal, entry into a charging stage and a charging operation can be performed (operation S130), and the charging operation can be terminated (operation S140).

An embodiment of the present disclosure can perform a post-charge fusion check (operation S150) according to the method described above, and can perform additional controls to prevent fire if there is a fusion situation.

If the post-charge fusion check is determined to be normal, the charging operation can be terminated (operation S160) and a connector can be removed (operation S170).

Further, if the fusion situation is detected by operations S110, S120, and/or S150, it can be checked whether the charging port flap is opened or closed (operation S210).

As a result, the relay of the high-voltage battery can be controlled to switch Off (operation S220) to prevent a fire hazard if the charging port flap is determined to be opened, and the relay of the high-voltage battery can be controlled to switch On (operation S230) to enable a normal operation of the vehicle if the charging port flap is determined to be closed (operation S240).

An embodiment of the present disclosure may secure the reliability of fusion determination by detecting a fusion situation before and after charging as described above, and may secure the driver's safety before and after charging by storing the status associated with the presence and absence of the fusion situation in NVRAM.

In an embodiment of the present disclosure, by controlling the high-voltage relay by conditions, it can be possible to prevent fire and explosion hazards caused by the connector by switching Off the high-voltage relay after starting or ending charging, and to maintain and secure the productivity provided by the vehicle such as a function of vehicle-starting/air conditioning/infotainment while controlling the high-voltage relay On in situations other than charging.

While the foregoing disclosure has been described with reference to the illustrative drawings, it can be apparent to those of ordinary skill in the art that embodiments of the present disclosure are not necessarily limited to the example embodiments described, and that various modifications and variations may be made without departing from the spirit and scopes of the present disclosure. Accordingly, such modifications or variations can be considered as falling within the scopes of the claims of the present disclosure, and the claims of the present disclosure can be construed based on the appended claims.

What is claimed is:

1. A fusion detection control system for a vehicle battery charging relay, the system comprising:
a high-voltage battery;
a high-voltage junction box connected with the high-voltage battery to distribute power from the high-voltage battery to a high-voltage component of a vehicle; and
a charge controller configured to detect whether the vehicle battery charging relay of the high-voltage junction box is fused after a completion of charging of the high-voltage battery.

2. The system of claim 1, wherein the charge controller is further configured to compare a first voltage of electric vehicle supply equipment (EVSE) and a second voltage of the high-voltage component,
wherein the charge controller is configured to determine an absence of a fusion situation if a voltage difference between the first voltage of the EVSE and the second voltage of the high-voltage component is not less than a threshold value, and
wherein the charge controller is configured to determine a presence of the fusion situation if the voltage difference is less than the threshold value.

3. The system of claim 2, wherein the threshold value is in a range of 45 volts to 55 volts.

4. The system of claim 1, wherein the charge controller is further configured to control a battery relay of the high-voltage battery to switch Off if the vehicle battery charging relay of the high-voltage junction box is determined to be fused after the completion of charging.

5. The system of claim 1, wherein the charge controller is further configured to check whether a charging port flap is opened or closed if the vehicle battery charging relay of the high-voltage junction box is determined to be fused after the completion of charging, and
wherein the charge controller is configured to control a battery relay of the high-voltage battery to switch Off if the charging port flap is determined to be opened.

6. The system of claim 5, wherein the charge controller is configured to check whether the charging port flap is opened or closed, and
wherein the charge controller is configured to control the battery relay of the high-voltage battery to switch On if the charging port flap is determined to be closed.

7. The system of claim 1, wherein the charge controller is further configured to check a variable value associated with a presence or an absence of a fusion situation previously stored in a memory to determine whether the fusion situation occurred in response to a request for entry into a charging stage, and wherein the charge controller is configured check whether a charging port flap is opened or closed if the fusion situation occurred, and wherein the charge controller is configured to control a battery relay of the high-voltage battery to switch Off if the charging port flap is determined to be opened.

8. The system of claim 7, wherein the charge controller is configured to check whether the charging port flap is opened or closed, and
wherein the charge controller is configured to control the battery relay of the high-voltage battery to switch On if the charging port flap is determined to be closed.

9. The system of claim 1, wherein, in response to a request for entry into a charging stage, the charge controller is configured to determine whether the vehicle battery charging relay of the high-voltage junction box is fused before charging of the high-voltage battery.

10. The system of claim 9, wherein if the vehicle battery charging relay of the high-voltage junction box is determined to be fused before charging of the high-voltage battery, the charge controller is configured to control a battery relay of the high-voltage battery to switch Off.

11. The system of claim 9, wherein the charge controller is configured to check whether a charging port flap is opened or closed if the vehicle battery charging relay of the high-voltage junction box is determined to be fused before charging of the high-voltage battery, and
wherein the charge controller is configured to control a battery relay of the high-voltage battery to switch Off if the charging port flap is determined to be opened.

12. The system of claim 11, wherein if the charging port flap is determined to be closed, the charge controller is configured to control the battery relay of the high-voltage battery to switch On.

13. A fusion detection control method for a vehicle battery charging relay, the method comprising:
charging a high-voltage battery in response to a request for entry into a charging stage; and
after a completion of charging of the high-voltage battery, checking whether the vehicle battery charging relay of a high-voltage junction box is fused, the high-voltage junction box being connected with the high-voltage battery to distribute power from the high-voltage battery to a high-voltage component of a vehicle.

14. The method of claim 13, wherein the checking whether the vehicle battery charging relay of the high-voltage junction box is fused comprises comparing a first voltage of electric vehicle supply equipment (EVSE) and a second voltage of the high-voltage component;
determining an absence of a fusion situation if a voltage difference between the first voltage of the EVSE and the second voltage of the high-voltage component is not less than a threshold value; and
determining a presence of the fusion situation if the voltage difference is less than the threshold value.

15. The method of claim 14, further comprising:
if the vehicle battery charging relay of the high-voltage junction box is determined to be fused in response to the checking the fusion situation of the vehicle battery charging relay of the high-voltage junction box, checking whether a charging port flap is opened or closed; and
if the charging port flap is determined to be opened, controlling a battery relay of the high-voltage battery to switch Off.

16. The method of claim 15, further comprising, if the charging port flap is determined to be closed in response to the checking whether the charging port flap is opened or closed, controlling the battery relay of the high-voltage battery to switch On.

17. The method of claim 14, further comprising:
in response to the request for entry into the charging stage prior to the charging of the high-voltage battery, checking a variable value associated with the presence or the absence of the fusion situation, wherein the variable value was previously stored in a memory; and
if the fusion situation is determined to be present based on the checking of the variable value, checking whether a charging port flap is opened or closed.

18. The method of claim 17, further comprising:
if the charging port flap is determined to be opened in response to the checking of whether the charging port flap is opened or closed, and the fusion situation is determined to be present based on the checking of the variable value, controlling a battery relay of the high-voltage battery to switch Off; and
if the charging port flap is determined to be closed in response to the checking of whether the charging port flap is opened or closed, and the fusion situation is determined to be present based on the checking of the variable value, controlling the battery relay of the high-voltage battery to switch On.

19. The method of claim 17, further comprising:
if the fusion situation is determined to be presented based on the checking of the variable value, checking whether the vehicle battery charging relay of the high-voltage junction box is fused before charging of the high-voltage battery; and
if the vehicle battery charging relay of the high-voltage junction box is determined to be fused in the checking of the fusion situation of the vehicle battery charging relay of the high-voltage junction box before charging of the high-voltage battery, checking whether the charging port flap is opened or closed.

20. The method of claim 19, further comprising:
if the charging port flap is determined to be opened in the checking whether the charging port flap is opened or closed in response to the vehicle battery charging relay of the high-voltage junction box being determined to be fused in the checking of the fusion situation of the vehicle battery charging relay of the high-voltage junction box before charging of the high-voltage battery, controlling a battery relay of the high-voltage battery to switch Off; and
if the charging port flap is determined to be closed in the checking whether the charging port flap is opened or closed in response to the vehicle battery charging relay of the high-voltage junction box being determined to be fused in the checking of the fusion situation of the vehicle battery charging relay of the high-voltage junction box before charging of the high-voltage battery, controlling the battery relay of the high-voltage battery to switch On.
